(19) United States
(12) Patent Application Publication
(10) Pub. No.: US 2008/0170230 A1
(43) Pub. Date: Jul. 17, 2008

(54) SILANIZATION OF NOBLE METAL FILMS

(75) Inventor: Daniele Gerion, Albany, CA (US)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: LamdaGen Corporation, Burlingame, CA (US)

(21) Appl. No.: 11/970,821

(22) Filed: Jan. 8, 2008

Related U.S. Application Data
(60) Provisional application No. 60/879,892, filed on Jan. 11, 2007.

(51) Int. Cl. G01N 21/55; B05D 3/10; B05D 1/36; B05D 1/38; B32B 9/04

(52) U.S. Cl. 356/445; 427/301; 428/447

(57) ABSTRACT

The present invention provides a method of preparing a silica layer on a surface, the method comprising contacting the surface with a first alkoxysilane and a first base, such that a first siloxane layer is formed on the surface; and contacting the first siloxane layer with a combination of a binding alkoxysilane, a growth limiting alkoxysilane and a second base, such that a second siloxane layer forms on top of the first siloxane layer, wherein the silica layer is prepared at a temperature of less than 100° C., and wherein the growth limiting alkoxysilane limits the thickness of the silica layer to less than 100 nm, thereby preparing the silica layer.

### BACKGROUND OF THE INVENTION

Surface Plasmon Resonance (SPR) is a label-free method able to monitor biomolecular interactions in real time. The technique makes use of an incident light impinging onto a metallic surface in contact with a dielectric medium (air, water or glass). Owing to a strong interaction between the light and the surface, a surface excitation called a surface plasmon is created at the interface between the metal and the dielectric. The frequency (i.e. λₘₐₓ) and intensity of the plasmon band are characteristic of the type of material and are highly sensitive to the local environment of the interface. In conventional SPR, the plasmon bands are rather broad and can sense environment changes up to distances of ˜200 nm away from the interface. The properties of the surface plasmons can be tuned by the patterning of the metallic surface with nanometer size features. The precise size and shape of these features generate plasmon excitations localized very close to the interface and decaying exponentially away from it. These localized plasmons exhibit relatively narrow (˜70-100 nm fwhm) and intense bands which are affected only by changes in the local environment at distances less than ˜20 nanometers away from the interface. The surface plasmons in this latter geometry are named Localized Surface Plasmons and give rise to the technique coined Localized Surface Plasmon Resonance (LSPR).

Properties of SPR and LSPR have prompted the development of sensors for biological and chemical reactions. Common to all these sensing platforms is the use of a metallic surface onto which a capture molecule is immobilized. The metallic surface is made of a noble metal. The noble metal surface acts as a transducer of binding events. In fact, during a chemical or biological reaction, a second molecule can bind to the immobilized species. This binding event produces a change in the local environment of the surface and affects the properties of the plasmons. By monitoring the position of the plasmon band maximum (denoted λₘₐₓ) in real time, one has access to the dynamics and kinetics of the biological or chemical interaction between the immobilized species and other molecules in solutions. Because localized surface plasmons decay much faster than regular surface plasmons with increasing distances from the interface, LSPR probes a much smaller volume than conventional SPR. Moreover since binding events happen at or very near the surface, LSPR has a much lower “dead volume” than SPR, i.e. volume where no binding occurs. As a consequence, the noise or bulk effect in LSPR is about 10 times smaller in LSPR than in SPR.

A key component in SPR and LSPR, and generally in all sensing platforms, is the use of the surface to act as a physical support for immobilization of bio-molecules or chemicals. This interface between the metal and the dielectric is the key component of the sensing platform because it acts as a signal transducer. In particular, the nature of the surface as well as the manner with which molecules, biomolecules or any generic capture probes are immobilized on the surface, greatly affects the performance of the sensor. In the case of SPR, current commercial systems use thin films of gold as sensing surface and surface chemistries based on proprietary dextran matrixes (BIACORE) or functional thiols to interface the plasmonic surface with the dielectric medium. Dextran is a highly cross-linked carbohydrate polymer which forms a porous 3D matrix between the Au film and the aqueous medium. Dextran has a very high immobilization capacity owing to its porous nature and a reduced non-specific adsorption versus bare gold. However, there is a limited flexibility in the chemical functionalization of this matrix. Furthermore, the Dextran matrix swells or shrinks if wetted or dried. These mechanical properties put a major constraint on the underlying noble metal layer and can easily disrupt the noble metal layer if the noble metal layer has a thickness of less than 100 nm. Finally, the porosity of the dextran matrix implies that capture molecules can sit deep inside the 3D network of the matrix where the motion of an analyte is constrained. Thus, the transport of the target molecules and analytes towards their capture probes is partially hindered by this porous 3D geometry. As a consequence, mass transport models need to be developed to quantitatively describe and fit experimental data.

Due to these complications, alternative surface functionalization and passivation (formation of a non-reactive surface film) methods have been pursued. Most routes make use of self-assembled monolayers (SAMs) on noble metal surfaces. These 2D monolayers are formed by close-packing hydrophobic molecules on the noble metal surface. For instance, alkanethiols are the ubiquitous choice to form SAMs. Alkanethiols functionalized with carboxylic or amine groups can also form SAMs. They are preferably used over simple alkanethiols for the conjugation of capture biomolecules onto the noble metal surface using carbodiimide chemistries. More complex alkanethiols, such as dendrimers or multi-thiolated molecules have been also used to build SAMs. Due to the simplicity of the approach and the chemistry involved, SAMs have become a popular method for the functionalization and passivation of the noble metal surface.

One drawback of SAMs technology includes the need of a clean, regular and flat noble metal surface to build a robust and consistent SAM. Since the new generation of LSPR surfaces heavily depend on nanostructured and shaped noble metal surfaces, the use of SAMs is more delicate in these cases. Other drawbacks include limited film stability, especially if SAMs are used in conjunction with detergents to reduce non-specific binding, potential problems with protein non-specific adsorption and fouling, poor orientation and biocompatibility. These limitations have prompted the development of alternative surface chemistries, such as glassification of the surface.

Glass is the material of choice for planar, patterned or rough biosensing platforms: it is cheap, biocompatible, stable, does not swell and benefits from the development of well-established surface chemistries for its functionalization and the reduction of non-specific adsorption. Notwithstanding, glass is the substrate of choice for high density DNA microarrays and the new generations of proteins chips. It seems natural to use glass as a functionalization/buffer layer at the interface between the noble metal surface and the aqueous solutions for LSPR and SPR sensors.

The strategy to overcoat surfaces of noble metal with glass for SPR and LSPR purposes has been pursued in the literature. In the case of Gold for instance, methods to grow silica on top of this noble metal film make use of chemical vapor deposition or a mix of sol/gel chemistry coupled with high temperatures. Chemical vapor deposition has been reported to produce glass surfaces with limited stability in phosphate buffered saline (PBS). Novel sol/gel techniques bypass this stability issue by growing a silica film layer-by-layer. In this latter process, a negatively charged silicate layer is adsorbed non-specifically on the noble metal surface followed by the deposition of a layer of a positively charge organic compound. The process of depositing negatively charged inorganic silicate followed by the positively charged organic layer is repeated many times until a desired thickness is obtained. Consolidation and cross-linking of the silicate into an extended and robust silica surface is then achieved by calcification at a temperature of ˜450° C. At this temperature, the organic matrix is burned off and silicate domains fuse into an extended silica network. This elegant approach is incompatible with the use polymer substrates or any substrates that do not withstand high temperatures.

What is needed is a general and purely sol/gel silanization process of films and surfaces that takes place without high temperature and makes use only of simple solvents. Surprisingly, the present invention meets this, and other, needs. The glassification or silanization method of the present invention is compatible with most polymer materials, with any noble metal materials and their alloys. The glassification or silanization method of the present invention is also compatible with any thin film morphology and thickness. For instance, the glassification technology can be applied to any nanopatterned surfaces including surfaces with thickness of 5 nm to well over a micron as well as to colloidal particles with diameters from less than 5 nm up to over a 100 um. The purpose of the silanization process is to create a specific base for immobilization of bio-molecules or chemicals. In fact, silica (glass)-coated surface sensors are robust and versatile. Silica-coated metallic sensors can be used to detect kinetics and dynamics of biological and chemical reactions using a multitude of optical and vibrational spectroscopies. Besides their use in SPR and LSPR, silica-coated noble metal sensors can be used in conjunction with ELSPR (Enhanced Localized Surface Plasmon Resonance), SERS (Surface-Enhanced Raman Spectroscopy) and CARS (Coherent Anti-Stokes Raman Spectroscopy) to gain access to the vibrational modes of chemicals and biomolecules bound to the surface.

### BRIEF SUMMARY OF THE INVENTION

In one embodiment, the present invention provides a method of preparing a silica layer on a surface. The method comprises contacting the surface with a first alkoxysilane and a first base, such that a first siloxane layer is formed on the surface. The method further comprises contacting the first siloxane layer with a combination of a binding alkoxysilane, a growth limiting alkoxysilane and a second base, such that a second siloxane layer forms on top of the first siloxane layer, wherein the silica layer is prepared at a temperature of less than 100° C., and wherein the growth limiting alkoxysilane limits the thickness of the silica layer to less than 100 nm, thereby preparing the silica layer.

In another embodiment, the first contacting step further comprises the steps of binding the first alkoxysilane to the surface; and contacting the bound first alkoxysilane with the first base so as to prepare the first siloxane layer.

In some embodiments, the present invention provides a method of preparing a silica layer on a surface, wherein the surface is planar. In other embodiments, the surface is patterned.

In another embodiment, the present invention provides a method of preparing a silica layer on a surface, wherein the surface is a member selected from the group consisting of a non-ferrous metal and an alloy of a non-ferrous metal. In a further embodiment, the surface is a member selected from the group consisting of gold, silver, copper, rhodium, palladium, platinum and tantalum.

In other embodiments, the present invention provides a method of preparing a silica layer on a surface, wherein the binding alkoxysilane and the growth limiting alkoxysilane are present in a ratio from 5:1 (w/w) binding alkoxysilane to growth limiting alkoxysilane to 1:5 (w/w). In still other embodiments, the first alkoxysilane and the binding alkoxysilane are each substituted with a member independently selected from the group consisting of mercapto, amine, ammonium, aldehyde, carboxy, aldehyde, ketone, ether, ester, acryl, acryloyl, methacryloyl, phosphate, polyethylene glycol, hydroxy, epoxy, isothiocyanate, isocyanate, hydrazine and acyl azides. In yet other embodiments, the first alkoxysilane is a mercaptopropyl-trialkoxysilane. In still yet other embodiments, the mercaptopropyl-trialkoxysilane is a member selected from the group consisting of mercaptopropyl-trimethoxy silane and mercaptopropyl-triethoxy silane. In another embodiment, the first alkoxysilane and the binding alkoxysilane are the same.

In some embodiments, the present invention provides a method of preparing a silica layer on a surface, wherein the growth limiting alkoxysilane is a polyethyleneoxide-trimethoxy silane. In some other embodiments, the polyethyleneoxide comprises from 3 to 100 ethyleneoxide units. In other embodiments, the growth limiting alkoxysilane is 2-[methoxy(polyethyleneoxy)propyl]trimethoxysilane, having from about 6 to about 9 polyethyleneoxy units.

In another embodiment, the present invention provides a method of preparing a silica layer on a surface, wherein the first base and the second base are independently selected from the group consisting of triethylamine, diisopropylethylamine, pyridine, tetramethylammonium hydroxide, tetraethylammonium hydroxide, sodium hydroxide, potassium hydroxide and N-methyl morpholine. In yet another embodiment, the first base and the second base are the same.

In a further embodiment, the present invention provides a method of preparing a silica layer on a surface, wherein the silica layer is prepared at a temperature of less than 60° C. In another embodiment, the silica layer is prepared at room temperature. In other embodiments, the silica layer has a thickness of less than 10 nm. In other embodiments, the time for preparing the silica layer is less than one day.

In other embodiments, the present invention provides a method of preparing a silica layer on a surface, wherein the silica layer comprises a dopant. In still other embodiments, the dopant is a member selected from the group consisting of a metal ion, a dye and a combination of a metal ion and a dye. In yet other embodiments, the metal ion is a paramagnetic metal ion selected from the group consisting of Gd³⁺, Mn²⁺ and Zn²⁺. In still yet other embodiments, the dye is a member selected from the group consisting of alexa, cyanine, rhodamine, fluorescein, Oregon green, Texas red, coumarins, pyrenes, Bodipy, cascade blue and lucifer yellow.

In another embodiment, the present invention provides a sensor surface prepared by the method described above for use in Surface Plasmon Resonance (SPR), Localized Surface Plasmon Resonance (LSPR), Enhanced Localized Surface Plasmon Resonance (ELSPR), Surface-Enhanced Raman Spectroscopy (SERS) or Coherent Anti-Stokes Raman Spectroscopy (CARS).

In a further embodiment, the present invention provides a system comprising a surface prepared by the method described above and a detection device selected from the group consisting of a plasmon resonance detection device and a vibrational detection device.

### BRIEF DESCRIPTION OF THE DRAWINGS

FIG. 1 shows the process of silanization of a noble metal surface. The silanization process is illustrated using gold (Au) as an example. In the first step (A), the Gold surface is primed with 3-mercaptopropyl-trimethoxy silane. The thiols bind to the gold surface via chemisorption, exposing the methoxysilane groups outwards. The methoxysilane groups are then hydrolyzed into silanol groups via water in the solution. Subsequently, weak silanol-silanol bridges form into siloxane bonds (B) using an alcoholic solution with a controlled amount of water and basicity of about 8-10. This step ensures the slow formation of a polymerized silica (glass) priming layer on top of the metal surface. Finally, the binding alkoxysilane and the growth limiting alkoxysilane are added to the mixture with the second base. Following hydrolysis of the alkoxysilane to hydroxy silanes, the hydroxy silanes condense with the hydroxy groups of the first siloxane layer and with other hydroxy silanes in solution, thereby forming the second siloxane layer and the complete silica layer (C). The R groups can be any functional group as described below.

FIG. 2 shows the dramatic reduction of non-specific binding provided by the silica layer on top of a Au surface. In panel (A), the same solution consisting of 500 nM (˜27 μg/ml) of streptavidin in PBS was incubated with nanopatterned Au surfaces passivated with several types of surfaces. These include a bare gold surface, a surface passivated with a tri-(ethylene glycol) alkane thiol (EG3) SAM, a surface passivated with a phosphine ligand (bisphenylsulfonate-phenylphosphine), and surfaces coated with the silica (glass) layer prepared by the method of the present invention. Upon addition of the streptavidin solution, the sensors responded by a shift in the plasmon frequency, λₘₐₓ, that is monitored in real time. As evidenced in panel (A), sensors with different surface passivation respond differently. Since there are no molecules on the surface to pair up with the streptavidin, the sensor responses must be zero at all time. Gold surfaces bearing silica layers prepared by the method of the present invention exhibit the least amount of non-specific binding as indicated by the almost zero-shift in λₘₐₓ. In panel (B), the silica has been functionalized with biotin, having a strong affinity for avidin and streptavidin. By exposing these modified glass surfaces to avidin or streptavidin, the sensor produces a shift in λₘₐₓ. The shift is suppressed, as expected, if the avidin and streptavidin are preincubated with an excess of free biotin that saturates their binding sites. This shows the specificity of biochemical analysis afforded by the use of the silica layers prepared by the method of the present invention.

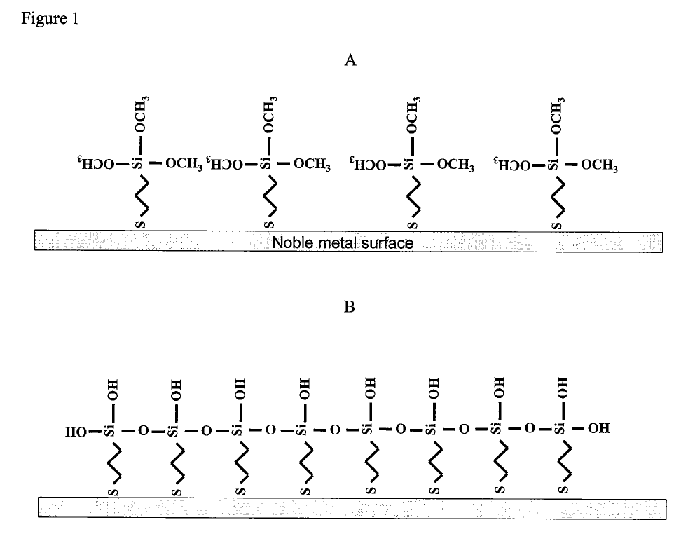

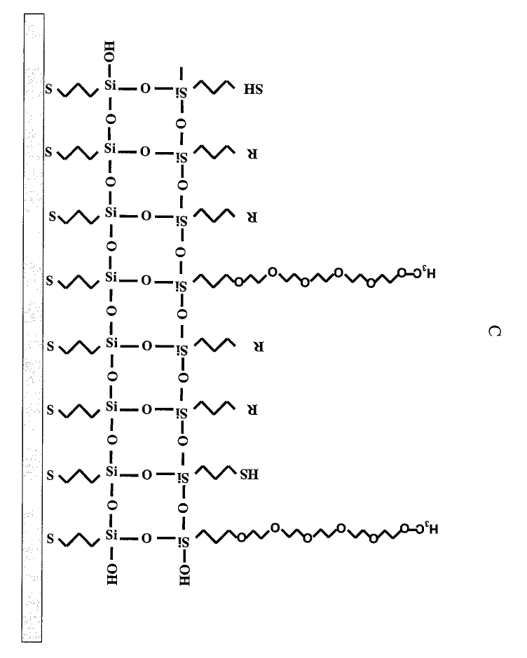

### DETAILED DESCRIPTION OF THE INVENTION

### I. INTRODUCTION

The present invention provides a method of making a thin silica film on a surface without the need for a layer by layer approach, and without the need for high temperature glassification. The method involves first preparing a self-assembled monolayer on a surface using a trialkoxysilane that has a functional group with an affinity for the surface. For example, when the surface is gold, then the functional group can be a mercapto group, and the alkoxysilane can be mercaptopropyl-triethoxysilane.

Upon coming into contact with the gold surface, the mercapto group binds to the gold surface, preparing the monolayer. Base catalyzes the replacement of the alkoxy groups with water present in solution to form hydroxy silanes. The hydroxy groups on each silane then condense with hydroxy groups on other silanes to form a network of silanes anchored to the surface. This is the first siloxane layer.

Following formation of the first siloxane layer, a mixture of polyethyleneoxide-triethoxysilane and more mercaptopropyl-triethoxysilane and base is added to the siloxane modified surface. The base again catalyzes the replacement of the alkoxy groups with water present in solution, and the newly formed hydroxy groups condense with hydroxy groups on other silanes in solution and with the hydroxy silanes of the first siloxane layer. In this manner, the silica layer grows. As a result of the steric bulk of the polyethyleneoxide, the growth of the silica layer is limited. Accordingly, a silica layer of less than 100 nm can be prepared at a temperature of less than 100° C.

### II. DEFINITIONS

As used herein, the term “silica layer” refers to a layer with repeating —Si—O— bonds wherein the layer is from 1 nm to 100 μm thick. The silica layer of the present invention comprises both the first and second siloxane layers prepared by the method of the present invention.

As used herein, the term “contacting” refers to the process of bringing into contact at least two distinct species such that they can react. It should be appreciated, however, that the resulting reaction product can be produced directly from a reaction between the added reagents or from an intermediate from one or more of the added reagents which can be produced in the reaction mixture.

As used herein, the term “alkoxysilane” refers to a silicon atom linked to at least one alkoxy group, wherein an alkoxy group refers to alkyl with the inclusion of an oxygen atom, for example, methoxy, ethoxy, propoxy, butoxy, pentoxy, hexoxy, etc. Alkoxysilanes of the present invention are of the formula RSiR′R″R′″, wherein at least one of R, R′, R″ and R′″ is an alkoxy group. Alkoxysilane can be mono-, di-, tri- or tetra-alkoxysilanes. Common alkoxysilanes include mono-alkoxysilanes and tri-alkoxysilanes. A “binding alkoxysilane” is one that binds to a surface. Binding alkoxysilanes can be bound to the surface via covalent linkages, such as a siloxane bond, or via chemisorption such as with a thiol, carboxylate or amine on a metal. A “growth limiting alkoxysilane” is an alkoxysilane having a bulky side chain that sterically hinders the growth of the siloxane layer. Sterically hindering groups include polyethyleneglycol, polyhydroxyalkyl, alkyl and aryl side groups. Additional sterically hindering side groups include, but are not limited to, dyes. One of skill in the art will appreciate that other alkoxysilanes are useful in the present invention.

As used herein, the term “base” refers to a substance that can accept protons, or a substance that is an electron pair donor. Bases useful in the present invention include amines, hydroxide and inorganic bases. Preferred bases include, but are not limited to, triethylamine, diisopropylethylamine, pyridine, tetramethylammonium hydroxide, tetraethylammonium hydroxide, sodium hydroxide, potassium hydroxide and N-methyl morpholine. The terms “first base” and “second base” refer to bases used in different steps of the method of the present invention, and can be the same base or different bases. One of skill in the art will appreciate that other bases are useful in the present invention.

As used herein, the term “siloxane layer” refers to a three-dimensional layer attached to a surface where the siloxane layer comprises organosilicon compounds with the formula R₂SiO. Each R group can optionally be an oxygen linked to another silicon atom.

As used herein, the term “non-ferrous metal” refers to metals other than iron. Non-ferrous metals that are useful in the present invention include the alkali metals, alkali earth metals, transition metals and post-transition metals (see discussion below).

As used herein, the term “metal ion” refers to elements of the periodic table that are metallic and that are positively charged as a result of having fewer electrons in the valence shell than is present for the neutral metallic element. Metals that are useful in the present invention include the alkali metals, alkali earth metals, transition metals other than iron, and post-transition metals.

As used herein, the term “dye” refers to a colorant, chromophore or fluorophore. Dyes useful in the present invention include, but are not limited to, alexa, cyanine, rhodamine, fluorescein, Oregon green, Texas red, coumarins, pyrenes, Bodipy, cascade blue and lucifer yellow. One of skill in the art will appreciate that other dyes are useful in the present invention.

### III. METHOD OF PREPARING A SILICA LAYER ON A SURFACE

The present invention provides a method of preparing a silica layer on a surface. The method comprises first contacting the surface with a first alkoxysilane and a first base, such that a first siloxane layer is formed on the surface. The method also comprises contacting the first siloxane layer with a combination of a binding alkoxysilane, a growth limiting alkoxysilane and a second base, such that a second siloxane layer forms on top of the first siloxane layer, wherein the silica layer is prepared at a temperature of less than 100° C., and wherein the growth limiting alkoxysilane limits the thickness of the silica layer to less than 100 nm, thereby preparing the silica layer.

A. Preparation of the First Siloxane Layer

The surface upon which the silica layer of the present invention is prepared can be any material. Exemplary surfaces include, but are not limited to, metal, ceramic, zeolite, glass, plastic, etc. Useful metals include elemental metals, metal oxides and alloys. Metals useful as the surface in the method of the present invention include ferrous and non-ferrous metals. Non-ferrous metals that are useful in the present invention include the alkali metals, alkali earth metals, transition metals and post-transition metals. Alkali metals include Li, Na, K, Rb and Cs. Alkaline earth metals include Be, Mg, Ca, Sr and Ba. Transition metals include Sc, Ti, V, Cr, Mn, Co, Ni, Cu, Zn, Y, Zr, Nb, Mo, Tc, Ru, Rh, Pd, Ag, Cd, La, Hf, Ta, W, Re, Os, Ir, Pt, Au, Hg and Ac. Post-transition metals include Al, Ga, In, Ti, Ge, Sn, Pb, Sb, Bi, and Po. Other non-ferrous metals useful in the present invention include alloys, such as brass.

In some embodiments, the surface can be gold, silver, copper, rhodium, palladium, platinum or tantalum. In other embodiments, the surface is gold.

The surface of the present invention can be planar or curved, such as on a spherical, elliptical or tubular surface. The surface can be a bulky flat surface, a thin film with thickness between 5 nm and a 1 mm, or it can be formed from colloidal noble metal particles deposited onto a generic surface. In addition, the surface can be patterned. When the surface is patterned, the patterning can be on the micro- or nano-scale. In some embodiments, any patterning provides features in the nanometer size regime, i.e., lateral and height dimensions between 1 nm and 100 μm. In other embodiments, the lateral and height dimensions are between 2 nm and 100 nm.

The silica layer is prepared by contacting the surface with a first alkoxysilane and a first base, such that a first siloxane layer is formed on the surface. The first siloxane layer is prepared by first chemisorbing the first alkoxysilane to the surface (via thiol on gold, for example). Base is then added, and the alkoxy silanes are condensed together using water and the base. The water displaces the alkoxy groups of the first alkoxysilane to form hydroxy silanes which then condense with each other to form the first siloxane layer. In some embodiments, some base is added along with the first alkoxysilane, and following chemisorption of the first alkoxysilane to the surface, more base is added along with the water, in order to facilitate condensation.

The first alkoxysilane can be any mono-, di- or tri-alkoxysilane that has an affinity for the surface. In some embodiments, the first alkoxysilane has the formula:

RSiR′R″R′″

wherein at least one of R′, R″ and R′″ is an C₁₋₆ alkoxy group, and R has a functional group with an affinity for the surface. Suitable R groups include mercapto, amine, ammonium, aldehyde, carboxy, ketone, ether, ester, acryl, acryloyl, methacryloyl, phosphate, polyethylene glycol, hydroxy, epoxy, isothiocyanate, isocyanate, hydrazine and acyl azides. In some embodiments, the R group includes mercapto, amine, carboxylate and phosphate. The alkoxy groups can be any suitable alkoxy group, such as methoxy, ethoxy, or others. Suitable alkoxysilanes can be obtained from commercial sources (such as Sigma-Aldrich and Gelest) or prepared via synthetic methods known to one of skill in the art. Alkoxysilanes can be mono-, di- or tri-alkoxysilanes. In some embodiments, tri-alkoxysilanes are preferred. In a preferred embodiment, the first alkoxysilane is a mercaptopropyl-trialkoxysilane. In another preferred embodiment, the mercaptopropyl-trialkoxysilane is a member selected from the group consisting of mercaptopropyl-trimethoxy silane and mercaptopropyl-triethoxy silane. One of skill in the art will appreciate that other alkoxysilane are useful in the present invention.

Bases useful in the method of the present invention can be any base. Bases useful in the present invention include amines, hydroxide and inorganic bases. Preferred bases include, but are not limited to, triethylamine, diisopropylethylamine, pyridine, tetramethylammonium hydroxide, tetraethylammonium hydroxide, sodium hydroxide, potassium hydroxide and N-methyl morpholine. The terms “first base” and “second base” refers to bases used in different steps of the method of the present invention, and can be the same base or different bases.

The first siloxane layer can be prepared using the first alkoxysilane and the first base in any suitable solvent. Solvents useful in the method of the present invention include, but are not limited to, hexane, benzene, toluene, alcohols such as methanol, ethanol, propanol, isopropanol, butanol and hexanol, water, dimethyl formamide, dimethyl sulfoxide, methylene chloride, 1-methyl-2-pyrrolidinone, and mixtures thereof. In some embodiments, the first siloxane layer is prepared using a mixture of ethanol and water. In other embodiments, the attachment to the surface of the first alkoxysilane is accomplished in ethanol, and the condensation is accomplished in water. One of skill in the art will appreciate that other solvents are useful in the present invention.

Any suitable temperature can be used to prepare the first siloxane layer of the present invention. In some embodiments, the temperature is less than about 100° C. In other embodiments, the temperature is less than about 60° C. In still other embodiments, the temperature is room temperature. One of skill in the art will appreciate that other temperatures are useful in the present invention.

The time needed for preparing the first siloxane layer can be any suitable time. In some embodiments, the time is less than about one day. Attachment of the first alkoxysilane to the surface can require several hours. In some embodiments, attachment can require about one hour. Condensation of the first alkoxysilane to form the first siloxane layer can require several hours, including up to about one day. In some embodiments, the condensation can be accomplished in less than one hour. In other embodiments, the condensation can be accomplished in about 30 minutes. One of skill in the art will appreciate that other times are useful in the present invention.

B. Preparation of the Second Siloxane Layer

The second siloxane layer can be prepared by contacting the first siloxane layer with a combination of a binding alkoxysilane, a growth limiting alkoxysilane and a second base. In some embodiments, the binding alkoxysilane has the formula:

RSiR′R″R′″

wherein at least one of R′, R″ and R′″ is a C₁₋₆ alkoxy group, and R has a functional group with an affinity for a biological species. Suitable R groups include mercapto, amine, ammonium, aldehyde, carboxy, aldehyde, ketone, ether, ester, acryl, acryloyl, methacryloyl, phosphate, polyethylene glycol, hydroxy, epoxy, isothiocyanate, isocyanate, hydrazine and acyl azides. The alkoxy groups can be any suitable alkoxy group, such as methoxy, ethoxy, or others. Suitable alkoxysilanes can be obtained from commercial sources (such as Sigma-Aldrich and Gelest) or prepared via synthetic methods known to one of skill in the art. Alkoxysilanes can be mono-, di- or tri-alkoxysilanes. In some embodiments, tri-alkoxysilanes are preferred. In other embodiments, the binding alkoxysilane is a member selected from the group consisting of aminopropyl-trimethoxy silane, aminopropyl-triethoxy silane, mercaptopropyl-trimethoxy silane and mercaptopropyl-triethoxy silane. One of skill in the art will appreciate that other alkoxysilanes are useful in the present invention as the binding alkoxysilane.

In some embodiments, the binding alkoxysilane is the same as the first alkoxysilane. In other embodiments, the second siloxane layer is prepared using a combination of the binding alkoxysilane, the growth limiting alkoxysilane and the first alkoxysilane.

In some other embodiments, the growth limiting alkoxysilane has the formula:

RSiR′R′R′″

wherein at least one of R′, R″ and R′″ is a C₁₋₆ alkoxy group, and R is sufficiently sterically bulky to limit the growth of the second siloxane layer. Suitable sterically bulky groups include, but are not limited to, polyethylene oxide, C₆₋₂₄ alkyl, C₆₋₂₄ heteroalkyl, aryl and aryl C₁₋₆ alkyl as well as dyes (as discussed below). The alkoxy groups can be any suitable alkoxy group, such as methoxy, ethoxy, or others. Suitable alkoxysilanes can be obtained from commercial sources (such as Sigma-Aldrich and Gelest) or prepared via synthetic methods known to one of skill in the art. Alkoxysilanes can be mono-, di- or tri-alkoxysilanes. In some embodiments, tri-alkoxysilanes are preferred.

In some embodiments, the growth-limiting alkoxysilane is a polyethyleneoxide-trimethoxy silane. The polyethyleneoxide component of the growth limiting alkoxysilane can be from 3 to 100 ethyleneoxide units long. In some embodiments, the polyethyleneoxide component is from 3 to 20 units long. In other embodiments, the polyethyleneoxide component is from 3 to 10 units long. An exemplary growth limiting alkoxysilane is 2-[methoxy(polyethyleneoxy)propyl]trimethoxysilane, having from about 6 to about 9 polyethyleneoxy units.

The binding alkoxysilane and the growth limiting alkoxysilane can be present in any ratio. In some embodiments, the binding alkoxysilane and the growth limiting alkoxysilane are present in a ratio of from 5:1 (w/w) to 1:5 (w/w) binding alkoxysilane to growth limiting alkoxysilane. Other ratios of the binding alkoxysilane and the growth limiting alkoxysilane are useful in the method of the present invention.

Bases useful as the second base in the method of the present invention can be any base. (See bases described above for the first base.) The first base and second base and can be the same base or different bases.

The second siloxane layer can be prepared using any suitable solvent. Solvents useful in the method of the present invention include those described above for preparation of the first siloxane layer. In some embodiments, the second siloxane layer is prepared using a mixture of ethanol and water. One of skill in the art will appreciate that other solvents are useful in the present invention.

Parameters for preparing the second siloxane layer, such as solvent, temperature and time, are described above for preparation of the first siloxane layer.

One of skill in the art will appreciate that other excipients and additives are also useful in the methods of the present invention.

The silica layer prepared by the method of the present invention can be of any thickness from 1 nm to about 100 μm. In some embodiments, the silica layer is characterized by having a thickness of from 1 nm to about 100 nm. In some other embodiments, the thickness of the silica layer is from 1 nm to about 10 nm. Thickness of the silica layer can be measured by technique's known to one of skill in the art, such as ellipsometry, XPS (X-ray Photoelectron Spectroscopy) and FIB (Focused Ion Beam).

The silica layer prepared by the method of the present invention can bind to any biological compound. Biological molecules that bind to the silica layer of the present invention include, but are not limited to, peptides, polypeptides, proteins, enzymes, antibodies, cells, nucleic acids and oligonucleotides (DNA and RNA). One of skill in the art will appreciate that other biological molecules are useful in the present invention.

The silica layer can also be functionalized with small molecules having chemical groups that can be linked to the functional groups present on the silica layer using hetero-bifunctional cross-linkers.

The silica layer prepared by the method of the present invention is robust for many months. The silica layer is compatible with conventional solvents (alcohol such as methanol, ethanol, butanol, propanol, organic solvents such as toluene, acetone, DMF, DMSO, N-Methyl Pyrrolidinone, among others); detergents (SDS, Tween 20, Tween 80, Triton X-100); aqueous buffers with pH ranging from 1 to 11; and acids (1M HCl, for example) and bases (1M NaOH and 1 M KOH, for example). In addition, the silica layer can be stored in the sunlight and regenerated many times without noticeable degradation.

The silica layer presents no, or minimal, non-specific adsorption of biomolecules. For instance avidin, one of the stickiest proteins, exhibits marginal non-specific adhesion to a silica-coated Au surface at concentrations exceeding 0.1 mg/ml (˜2 μM) in PBS.

### IV. SILICA LAYER AS A SENSOR SURFACE

In some embodiments, the present invention provides a sensor surface prepared as described above for use in detection devices such as plasmon resonance or vibrational detection devices. In some embodiments, detection devices useful in the present invention include, but are not limited to, Surface Plasmon Resonance (SPR), Localized Surface Plasmon Resonance (LSPR), Enhanced Localized Surface Plasmon Resonance (ELSPR), Surface-Enhanced Raman Spectroscopy (SERS), Coherent Anti-Stokes Raman Spectroscopy (CARS), Nuclear Magnetic Resonance (NMR) or Magnetic Resonance Imaging (MRI). One of skill in the art will appreciate that other detection devices are useful in the present invention.

### V. SYSTEM

In some embodiments, the present invention provides a system comprising a surface prepared as described above, and a detection device selected from the group consisting of a plasmon resonance detection device and a vibrational detection device. The plasmon resonance and vibrational detection devices useful in the systems of the present invention are described above.

### VI. EXAMPLES

### Example 1

### Preparation of Silica Layer

The first siloxane layer was prepared by first preparing a monolayer of tri-alkoxy silanes and then polymerizing the tri-alkoxy silanes to form the first siloxane layer. The sensor surface was rinsed with 0.05% Tween 20 in MilliQ-water and the solution was allowed to sit for ˜20 min, followed by rinsing with MilliQ-water and drying with nitrogen. A solution of 18 μl of 3-mercapto-propyl-trimethoxysilane, 1200 μl of ethanol and 60 μl of a basified ethanol (made from 3 μl tetramethylammonium hydroxide and 1000 μl ethanol) was prepared. 30 μl of this solution was then added to each well of the sensor surface and allowed to react for 60 minutes. The sensor surface was then rinsed with MilliQ-water and dried with nitrogen.

The sensor surface was incubated for 60 minutes in basified MilliQ-water (made from 1000 μl MilliQ-water and 3 μl tetramethylammonium hydroxide). The sensor surface was then rinsed with MilliQ-water and dried with nitrogen.

The second siloxane layer was then prepared by 30 μl of a solution made from 1000 μl basified ethanol (made from 3 μl tetramethylammonium hydroxide and 1000 μl ethanol), 150 μl MilliQ-water, 200 μl 2-[methoxy(polyethylenoxy)-propyl]-trimethoxysilane, 3 μl 3-mercapto-propyl-trimethoxysilane and 97 μl ethanol. The solution was incubated for about 4-5 hours, followed by rinsing the sensor surface with MilliQ-water and drying with nitrogen.

### Example 2

### A System

This example demonstrates the bioactivation of mercapto- (or sulfhydryl-) terminated silica surfaces with biotinylation of the surface. Additional details and alternative strategies can be found in the following book: G. T. Hermanson, Bioconjugate Techniques, Academic Press, San Diego, 1996.

A surface was first prepared according to the protocol in Example 1. The surface was modified with biotin according to the following protocol.

This protocol involves activation with commercial maleimide-biotin. A solution of maleimide-biotin is dissolved in PBS at a concentration of 20 mM and incubated on the mercapto-terminated silica surface for 20-30 minutes. The surface is then rinsed with ddH2O. It is ready for the streptavidin binding test.

Alternatively, the biotin is linked to the mercapto-terminated silica surface using a hetero-bifunctional crosslinker, linking the sulfhydryls group of the surface to the carboxy group of biotin. First, a solution of (100 mM SMCC+150 mM of Ethylenediamine dihydorchloride) in PBS is added to the mercapto-terminated silica surface and is incubated for 1 hr after which it is rinsed away. This step converts the surface to an amine-terminated surface. Subsequently, a solution of 20 mM biotin dissolved in MES is incubated on the amine-surface along with 400 mM EDC and 100 mM NHS for 1 hr. This results in the covalent binding of the biotin to the aminated-surface.

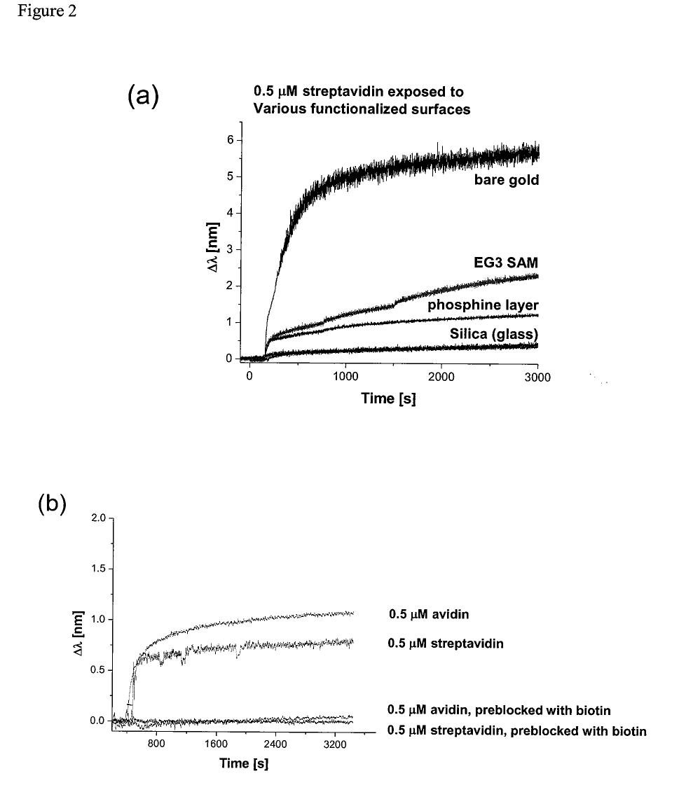

Streptavidin is then bound to the biotinylated surface. Solutions of streptavidin with concentrations ranging from 1 nM up to 10 μM were be prepared in PBS. These solutions were added directly to the biotinylated surfaces and the shift in the plasmon position was monitored. The presence of a shift is indicative of a binding (FIG. 2B). To further assess if the binding is specific or not, the solutions of streptavidin were pre-incubated with 50 μM free biotin to block the binding sites of the streptavidin. When these preblocked streptavidin solutions are exposed to the biotinylated surface, no shift in the LSPR signal is observed (FIG. 2B) showing that the binding of streptavidin to the surfaces is specific.

Detection of the shift in the plasmon position can be performed by monitoring the absorption of white light (i.e. from a tungsten halogen lamp) by the LSPR surface using a USB spectrometer detecting wavelengths between 480 nm and 650 nm.

Although the foregoing invention has been described in some detail by way of illustration and example for purposes of clarity of understanding, one of skill in the art will appreciate that certain changes and modifications may be practiced within the scope of the appended claims. In addition, each reference provided herein is incorporated by reference in its entirety to the same extent as if each reference was individually incorporated by reference.

What is claimed is:

1. A method of preparing a silica layer on a surface, the method comprising:
contacting the surface with a first alkoxysilane and a first base, such that a first siloxane layer is formed on the surface; and
contacting the first siloxane layer with a combination of a binding alkoxysilane, a growth limiting alkoxysilane and a second base, such that a second siloxane layer forms on top of the first siloxane layer, wherein the silica layer is prepared at a temperature of less than 100° C., and wherein the growth limiting alkoxysilane limits the thickness of the silica layer to less than 100 nm, thereby preparing the silica layer.

2. The method of claim 1, wherein the first contacting step further comprises the steps of:
binding the first alkoxysilane to the surface; and
contacting the bound first alkoxysilane with the first base so as to prepare the first siloxane layer.

3. The method of claim 1, wherein the surface is planar.

4. The method of claim 1, wherein the surface is patterned.

5. The method of claim 1, wherein the surface is a member selected from the group consisting of a non-ferrous metal and an alloy of a non-ferrous metal.

6. The method of claim 5, wherein the surface is a member selected from the group consisting of gold, silver, copper, rhodium, palladium, platinum and tantalum.

7. The method of claim 1, wherein the binding alkoxysilane and the growth limiting alkoxysilane are present in a ratio from 5:1 (w/w) binding alkoxysilane to growth limiting alkoxysilane to 1:5 (w/w).

8. The method of claim 1, wherein the first alkoxysilane and the binding alkoxysilane are each substituted with a member independently selected from the group consisting of mercapto, amine, ammonium, aldehyde, carboxy, aldehyde, ketone, ether, ester, acryl, acryloyl, methacryloyl, phosphate, polyethylene glycol, hydroxy, epoxy, isothiocyanate, isocyanate, hydrazine and acyl azides.

9. The method of claim 8, wherein the first alkoxysilane is a mercaptopropyl-trialkoxysilane.

10. The method of claim 9, wherein the mercaptopropyl-trialkoxysilane is a member selected from the group consisting of mercaptopropyl-trimethoxy silane and mercaptopropyl-triethoxy silane.

11. The method of claim 8, wherein the first alkoxysilane and the binding alkoxysilane are the same.

12. The method of claim 1, wherein the growth limiting alkoxysilane is a polyethyleneoxide-trimethoxy silane.

13. The method of claim 12, wherein the polyethyleneoxide comprises from 3 to 100 ethyleneoxide units.

14. The method of claim 12, wherein the growth limiting alkoxysilane is 2-[methoxy(polyethyleneoxy)propyl]trimethoxysilane, having from about 6 to about 9 polyethyleneoxy units.

15. The method of claim 1, wherein the first base and the second base are independently selected from the group consisting of triethylamine, diisopropylethylamine, pyridine, tetramethylammonium hydroxide, tetraethylammonium hydroxide, sodium hydroxide, potassium hydroxide and N-methyl morpholine.

16. The method of claim 15, wherein the first base and the second base are the same.

17. The method of claim 1, wherein the silica layer is prepared at a temperature of less than 60° C.

18. The method of claim 1, wherein the silica layer is prepared at room temperature.

19. The method of claim 1, wherein the silica layer has a thickness of less than 10 nm.

20. The method of claim 1, wherein the time for preparing the silica layer is less than one day.

21. A sensor surface prepared by the method of claim 1 for use in Surface Plasmon Resonance (SPR), Localized Surface Plasmon Resonance (LSPR), Enhanced Localized Surface Plasmon Resonance (ELSPR), Surface-Enhanced Raman Spectroscopy (SERS) or Coherent Anti-Stokes Raman Spectroscopy (CARS).

22. A system comprising:
a surface prepared by the method of claim 1;
a detection device selected from the group consisting of a plasmon resonance detection device and a vibrational detection device.
